(19) United States
(12) Patent Application Publication
(10) Pub. No.: US 2012/0326521 A1
(43) Pub. Date: Dec. 27, 2012

(54) DETECTION OF AN ELECTRICALLY CONDUCTIVE FOREIGN OBJECT IN AN INDUCTIVE TRANSMISSION PATH

(75) Inventors: Hans-Achim Bauer, Hamburg (DE); Andre Zybala, Hanstedt (DE)

(73) Assignee: AIRBUS OPERATIONS GMBH, Hamburg (DE)

(21) Appl. No.: 13/529,209

(22) Filed: Jun. 21, 2012

Related U.S. Application Data
(60) Provisional application No. 61/499,266, filed on Jun. 21, 2011.

(30) Foreign Application Priority Data
Jun. 21, 2011 (DE) 10 2011 105 063.2

(51) Int. Cl. H01F 38/14

(52) U.S. Cl. 307/104

(57) ABSTRACT

A system for contactless inductive energy transmission includes a primary system and a secondary system. The primary system comprises a first modulation unit that is configured to convert an energy signal to a first modulated alternating voltage signal. Furthermore, the primary system comprises a primary element that is configured to inductively transmit the first modulated alternating voltage signal. The secondary system comprises a secondary element that is configured to receive the first modulated alternating voltage signal. Moreover, the primary system comprises a primary control unit and a first measuring unit configured to determine a first parameter of the system and to transmit it to the primary control unit. Therein, the primary control unit is configured, depending on the first parameter, to determine whether at least one electrically conductive foreign object is located in the inductive transmission path between the primary element and the secondary element.

### CROSS-REFERENCE TO RELATED APPLICATIONS

The present application claims the benefit of the filing date of U.S. Provisional Patent Application No. 61/499,266 filed Jun. 21, 2011 and German Patent Application No. 10 2011 105 063.2, filed Jun. 21, 2011, the disclosures of which applications are hereby incorporated herein by reference.

### FIELD OF THE INVENTION

The present invention relates to a system and a corresponding method for contactless inductive energy transmission that makes it possible to detect an electrically conductive foreign object in the inductive transmission path.

### BACKGROUND OF THE INVENTION

Contactless transmission of data and energy is of importance in many technical fields. For example, electrical energy may be converted to magnetic fields which may transport the energy, for example, also through materials. In another location the magnetic fields may be converted back to electrical energy.

The energy inductively transmitted in this manner may be combined with data in that, for example, the magnetic field is modulated in a certain frequency. A corresponding system is, for example, known from DE 10 2008 024 217 A1 and US 2009 295 223 A1.

If an electrically conductive foreign object is in the transmission path of the magnetic fields, this may have a negative influence both on the transmission of energy and on the transmission of data.

### BRIEF SUMMARY OF THE INVENTION

There thus may be a need for the detection of a foreign object with as much accuracy as possible, in particular of an electrically conductive foreign object in an inductive transmission path of a contactless energy system or of a contactless energy transmission system.

According to a first aspect of the invention, a system for contactless inductive energy transmission with the possibility of foreign object detection is described. The system comprises a primary system and a secondary system. Therein, the primary system comprises a first modulation unit that is configured for converting a predetermined first energy signal to a first modulated alternating voltage signal. Furthermore, the primary system comprises a primary element that is configured for inductively transmitting the first modulated alternating voltage signal. The secondary system comprises a corresponding secondary element that is configured for inductively receiving the first modulated alternating voltage signal. Furthermore, the primary system comprises a primary control unit and a first measuring unit that is configured for determining a first parameter of the system and to transmit it to the primary control unit. Therein, the primary control unit is configured for, determining depending on the first parameter whether at least one electrically conductive foreign object is situated in the inductive transmission path between the primary element and the secondary element.

In other words, the idea of the present invention may be based on making it possible to detect a fault current caused by an electrically conductive foreign object in the transmission path. For this purpose the first measuring unit is provided which determines the first parameter that may be typical of the system, and transmits said parameter to the primary control unit for evaluation. Therein, the first parameter may vary, depending on the presence of an electrically conductive foreign object in a transmission path between the primary element and the secondary element. Therein, the first parameter may, for example, be a complex resistance of the primary element, which may be typically representative of a complex resistance of a resonant circuit formed by the primary element and the secondary element. As an alternative, the first parameter may be representative of the electrical power provided by the primary system.

Subsequently, in the primary control unit an evaluation of the first parameter may take place, based on which it may be detected whether an electrically conductive material is undesirably situated in the inductive transmission path.

Therein, the system according to the invention may, for example, be used in vehicles, in particular in aircraft. The primary element and the secondary element may, for example, comprise inductive coils, where appropriate with a ferrite core, which coils may transmit electrical energy and information across an air gap. Therein, the primary system may, for example, be arranged so as to be stationary, or fixed to the vehicle, for example in the floor of a cabin. Therein, the secondary system may, for example, be integrated in a mobile component that may be arranged within the vehicle. For example, the secondary system may be arranged in a vehicle seat so that the secondary element may be arranged above the primary element, which is integrated in the floor, so that both elements may inductively communicate with each other. The predetermined energy signal transmitted by the system may, for example, be used to supply power to a passenger seat.

The secondary system may, furthermore, comprise a conversion unit that is configured for converting the received modulated alternating voltage signal to a second energy signal.

Below, the advantages of the system according to the invention are explained with reference to an example of the installation of the system in an aircraft. However, this example is not to be interpreted as limiting the invention.

During initial installation of a contactless energy transmission system in the manufacture of an aircraft it should be ensured that the region of the inductive transmission system is free of, for example, drilling chips, screws, nuts, washers, tools and any other electrically conductive elements. It may be tested for example, by a metal detector device whether the transmission system is free of any undesirable electrically conductive elements. The use of the metal detector device typically involves increased manufacturing effort and thus also increased manufacturing costs.

Furthermore, during operation of a contactless energy transmission system it should be ensured that no electrically conductive elements, for example chewing gum paper, hairpins, paper clips, coins and similar, may find their way into the inductive transmission path. Solving this problem by adapting the mechanical design of the system may cause additional expenditure of time, additional weight, and additional costs.

The system according to the invention with the possibility of detecting an electrically conductive foreign object by a first measuring unit may overcome the problems that occur during initial installation and during operation. In other words, the system according to the invention with an integrated possibility of foreign object detection may contribute to saving costs and weight, while at the same time ensuring safe continuous operation of the contactless energy transmission system.

Contactless energy transmission of the system according to the invention takes place inductively, for example by electromagnets. The primary system comprises the first modulation unit, which may, for example, be connected to an inverter that may provide the first energy signal. The first energy signal may be converted to form the first modulated alternating voltage signal. To this effect the primary control unit may be designed to control the first modulation unit. The first modulation unit may, for example, be integrated in the primary control unit or in the inverter.

A primary element, for example a coil with windings and where appropriate with a ferrite core, may be connected to the signal output of the primary control unit e.g. by way of an inverter. Therein, the primary element may transform the first modulated alternating voltage signal to electromagnetic waves, and may inductively transmit them to the corresponding secondary element of the secondary system. Therein, the first modulated alternating voltage signal may, for example in the form of a magnetic field or electromagnetic waves, be transmitted to the secondary element. Therein, the first modulated alternating voltage signal may be frequency-modulated or amplitude-modulated. Furthermore, the first modulated alternating voltage signal may comprise a combination of frequency modulation and amplitude modulation.

The signal emitted by the primary element induces a current or a voltage in the opposite secondary element. Substantially in this manner, the first modulated alternating voltage signal may be received in the secondary element, which, for example, may also be implemented as a coil with windings and a ferrite core. Therein, the secondary element may be connected with a signal input of a secondary control unit, and may forward the received signal to said secondary control unit. The first modulated alternating voltage signal may be transmitted with a certain loss of energy, corresponding to the efficiency of the system. For this reason the first modulated alternating voltage signal may be present in a slightly weakened form at the secondary control unit.

Therein, the secondary control unit may be configured for demodulating received signals, and, where appropriate, at an output provide data. Furthermore, by the conversion unit, e.g. a rectifier, the first modulated alternating voltage signal may be converted to a second energy signal and may be provided for a consumer.

The first measuring unit, which may additionally be integrated into the primary system, may, for example, comprise one or several sensors or may be designed as such sensors. If the first measuring unit is configured for determining a complex resistance, also referred to as “impedance”, or to determine an electrical power of the primary system, then the sensor or sensors be integrated directly in the electrical circuit of the primary system and may be electrically coupled to the primary element and to the primary control unit. The first parameter to be determined may, furthermore, be a temperature change that arises as a result of an overcurrent in the inductive transmission path. The temperature change may, for example, be determined directly in the primary element.

The first parameter depends on the “purity” of the transmission path between the primary element and the secondary element.

According to an exemplary embodiment of the invention, the first modulation unit is configured for converting a predetermined data signal, together with the first energy signal, to the first modulated alternating voltage signal.

Therein, the first modulation unit may convert the first energy signal and the predetermined data signal to a common signal, namely to the first modulated alternating voltage signal. Therein, data that is transmitted by the data signal may be predetermined, i.e. predetermined by a user or predetermined automatically. The primary control unit may, for example, be configured for providing the predetermined data signal to the first modulation unit, and to correspondingly control said first modulation unit.

According to a further exemplary embodiment of the invention, the first measuring unit is configured for determining a complex resistance of the primary element as the first parameter.

Therein, the primary control unit may preferably compare the complex resistance with a predeterminable threshold value. The threshold value may, for example, be stored in the primary control unit, or it may be set or entered by a user. The threshold value may be set differently for different measurements. For example, the threshold value may vary depending on a length of the transmission path or on a distance between the primary element and the secondary element. Furthermore, the threshold value may depend on the number of consumers and on the energy consumption of the consumers connected to the system. Preferably, the primary control unit may be configured for determining, depending on the comparison with the predetermined threshold value, whether at least one foreign object is present in the transmission path.

Both the primary element and the secondary element may be designed as electromagnetic resonant circuits for which a complex resistance is determinable. Said circuits may cooperate in the inductive transmission of the energy and of the data.

The complex resistance may be determined in ohm and may indicate a ratio of amplitudes of the alternating current voltage and of the alternating current which may, for example, be tapped by the consumers. Furthermore, the complex resistance indicates the phase shift between the alternating voltage and the alternating current. Therein, the first measuring unit may comprise several sensors for different individual measured values for determining the complex resistance.

According to a further exemplary embodiment of the invention, the primary control unit is configured for generating a warning signal, for example a switch-off signal, of the system when the first parameter differs from the threshold value by more than a predeterminable amount. As an alternative, the primary control unit may be configured for initiating the switching-off of the system directly or automatically when the first parameter differs from the threshold value by more than a predeterminable amount. For example, if the determined complex resistance is greater than the threshold value by a determined amount, the system is automatically switched off. In this manner the system may be protected from damage, e.g. as a result of excessive overcurrents.

According to a further exemplary embodiment of the invention, the secondary system comprises a second measuring unit that is configured for determining a second parameter of the secondary system. The second measuring unit may, for example, be designed in analogy to the first measuring unit and may be directly integrated in the electrical circuit of the secondary system. Therein, the primary control unit is configured for comparing the first parameter with the second parameter, and based on the comparison to determine whether at least one electrically conductive foreign object is located in the inductive transmission path between the primary element and the secondary element.

Therein, the determined second parameter may be converted to a second modulated alternating voltage signal by a second modulation unit integrated in the secondary system. For this purpose the secondary control unit may be configured for converting the second parameter to a data signal, and to correspondingly control the second modulation unit so that it generates the second modulated alternating voltage signal. The second modulation unit may, for example, be integrated in the secondary control unit, or may be arranged in the transmission path between the secondary control unit and the secondary element. Furthermore, for conveying the second parameter, where appropriate, a small part of the energy signal received by the secondary element may be branched off and supplied to the second modulation unit. The data signal and the energy signal together may be converted to form the second modulated alternating voltage signal, and by the secondary element may be conveyed, across the air gap, to the primary element. From the primary element the second modulated alternating voltage signal may be forwarded to the primary control unit.

Therein, the first measuring unit may be configured for determining an electrical power of the primary system as the first parameter. The second measuring unit may be configured for determining an electrical power of the secondary system as the second parameter. Therein, the first parameter represents an electrical power of the primary system. The second parameter represents an electrical power of the secondary system.

Therein, the electrical power may be proportional to a voltage and to a current. For example, the electrical power of the primary system may be proportional to the voltage fed to the primary system and to the induced current. Therein, the first measuring unit and the second measuring unit may be configured for acquiring current values and voltage values, depending on the aforesaid to determine the respective parameter, and to convey said parameter to the respective control unit.

A magnetic efficiency of the system may be known or may be determined and for example, exceeds 97%. Thus it may approximately be assumed that in the case of a transmission path free of foreign objects the power balance of the system may approximately be in balance. In other words, the electrical power of the primary system approximately corresponds to the electrical power of the secondary system.

An electrically conductive foreign object in the inductive transmission path disturbs this power balance. In the foreign object a voltage is induced by the first modulated alternating voltage signal. Thus, part of the power emitted by the primary system goes to the foreign object. If the electrically conductive foreign object is present in the inductive transmission path, for example in the air gap between the primary element and the secondary element, in terms of the power balance the electrical power of the primary system approximately corresponds to the sum of the electrical power of the secondary system and the power going to the electrically conductive foreign object.

Thus, a difference between the power of the primary system, which power has been determined by the first measuring unit, and the power of the secondary system, which power has been determined by the second measuring unit, indicates the presence of a foreign object in the transmission path.

According to a further exemplary embodiment of the invention, the first measuring unit and the second measuring unit are configured for synchronously determining the respectively allocated parameter.

For example, the first measuring unit and the second measuring unit may be configured for synchronously determining the power of the primary system and the power of the secondary system. In other words, the first measuring unit and the second measuring unit may be triggered at the same time so that the power values of the two systems are determined at the same time. This may improve the measuring accuracy or the quality of the evaluation.

According to a further exemplary embodiment of the invention, the system comprises a second modulation unit, which is configured for converting the second parameter to a second modulated alternating voltage signal and to transmit it to the secondary element. Furthermore, the secondary element is configured for inductively transmitting the second modulated alternating voltage signal to the primary element.

In this manner, the information relating to the first parameter and the second parameter may be collected and compared in the first primary unit. This exemplary embodiment implies bidirectional data transmission or information transmission of the system. To this effect the second parameter may be conveyed from the second measuring unit to the secondary control unit, which is connected to the second modulation unit and controls the aforesaid in order to generate the second modulated alternating voltage signal. The second modulation unit may e.g. be integrated in the secondary control unit, or it may be arranged in the transmission path between the secondary control unit and the secondary element. For example, in addition to the signal input the secondary control unit may comprise a signal output connected to the secondary element. Furthermore, in addition to the signal output the primary control unit may comprise a signal input by which information relating to the second parameter may be conveyed to the primary control unit by the primary element.

Furthermore, the primary control unit may be configured for generating a warning signal, for example a switch-off signal, when the electrical power of the primary system differs excessively from the electrical power of the secondary system. In this manner the system may be protected from damage, e.g. as a result of overcurrents.

Converting the determined second parameter to the second modulated alternating voltage signal may, for example, also take place by modulation.

According to a second aspect of the invention, a method for detecting an electrically conductive foreign object in an inductive transmission path of a contactless inductive energy transmission system as presented above is described. The method involves the following steps: determining a first parameter of the system by a first measuring unit; transmitting the first parameter to a primary control unit; comparing the determined first parameter with a predeterminable threshold value; issuing a predetermined warning signal when the determined first parameter differs from the threshold value by more than a predeterminable range. Therein, issuing the warning signal typically represents the presence of an electrically conductive foreign object in the inductive transmission path between the primary element and the secondary element.

According to a third aspect of the invention, the use, in an aircraft, of the system presented above is described.

According to a fourth aspect of the invention, an aircraft with a system presented above is described. Therein, the primary system may, for example, be integrated in the cabin floor or underneath the cabin floor. The secondary system may, for example, be integrated in passenger seats.

Further features and advantages of the invention will be evident to the person skilled in the art from the subsequent description of exemplary embodiments, which are, however, not to be interpreted as limiting the invention, with reference to the enclosed figures.

### BRIEF DESCRIPTION OF THE DRAWINGS

FIG. 1 shows a schematic section of a system for contactless inductive energy transmission,

FIG. 2 shows a schematic section of a system for contactless inductive energy transmission with an electrically conductive foreign object located in the transmission path,

FIG. 3 schematically shows the system for contactless inductive energy transmission according to an exemplary embodiment of the invention,

FIG. 4 schematically shows the system for contactless inductive energy transmission according to a further exemplary embodiment of the invention.

All figures merely depict schematic representations of devices according to the invention or their components. In particular, spaces and size relationships are not depicted true to scale in the figures. The same or identical elements in the figures have the same reference characters.

### DETAILED DESCRIPTION

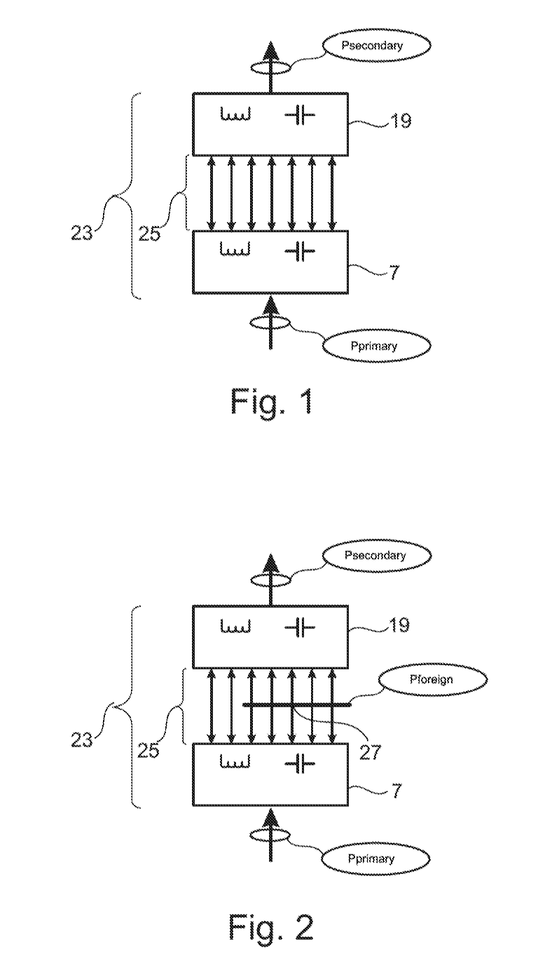

FIGS. 1 and 2 each show a section of a system 1 for contactless inductive energy transmission. Therein, FIG. 1 shows a transmission path 23 without an electrically conductive foreign object 27, and FIG. 2 with an electrically conductive foreign object 27. The inductive transmission path 23 shown in FIGS. 1 and 2 comprises an energy-supplying primary element 7 and an energy-receiving secondary element 19. The primary element 7 and the secondary element 19 in respectively comprise coils with a ferrite core. Between the primary element 7 and the secondary element 19 there is an air gap 25. The system 1 may, for example, be used in an aircraft in order to, for example, supply energy in a contactless manner to cabin installations, for example seats. The energy to be transmitted may, for example, be transmitted in a contactless manner in the form of electromagnetic radiation across the air gap 25. Therein, the magnetic efficiency may, for example, be better than 97%. In order to be able to ensure such high magnetic efficiency, the transmission path 23 needs to be free of any undesirable electrically conductive materials such as, for example, foreign objects 27.

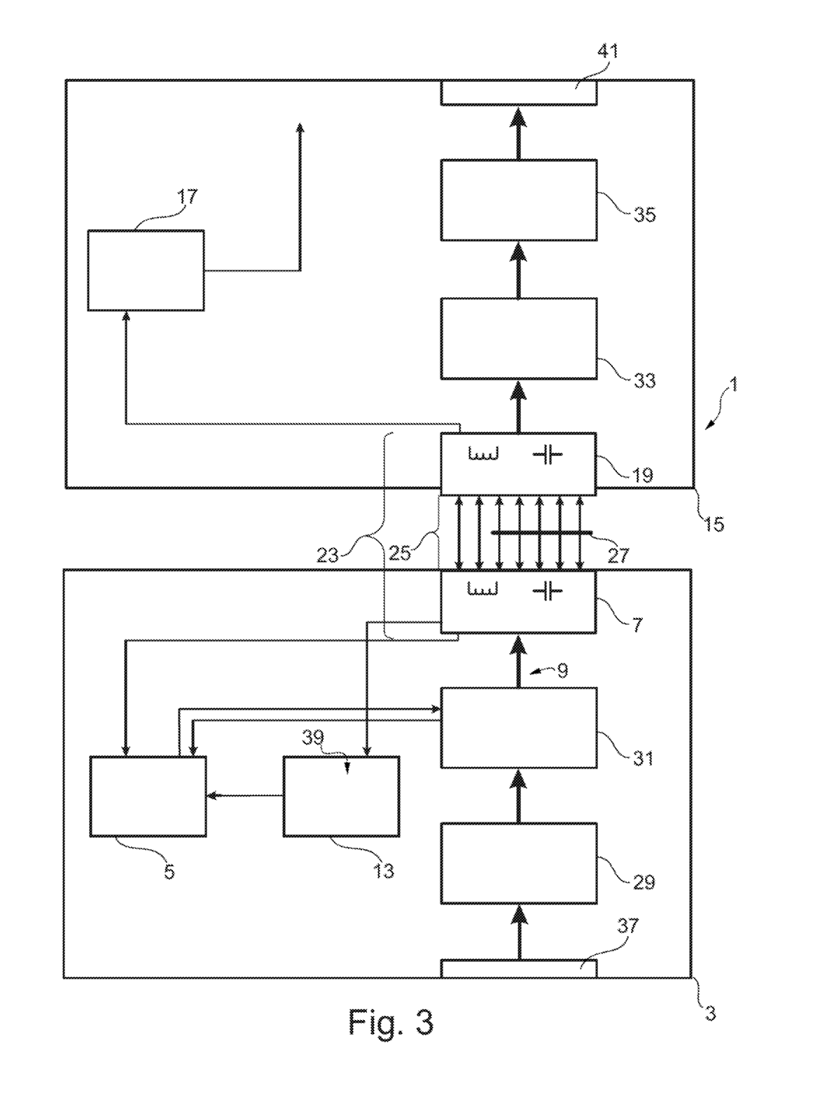

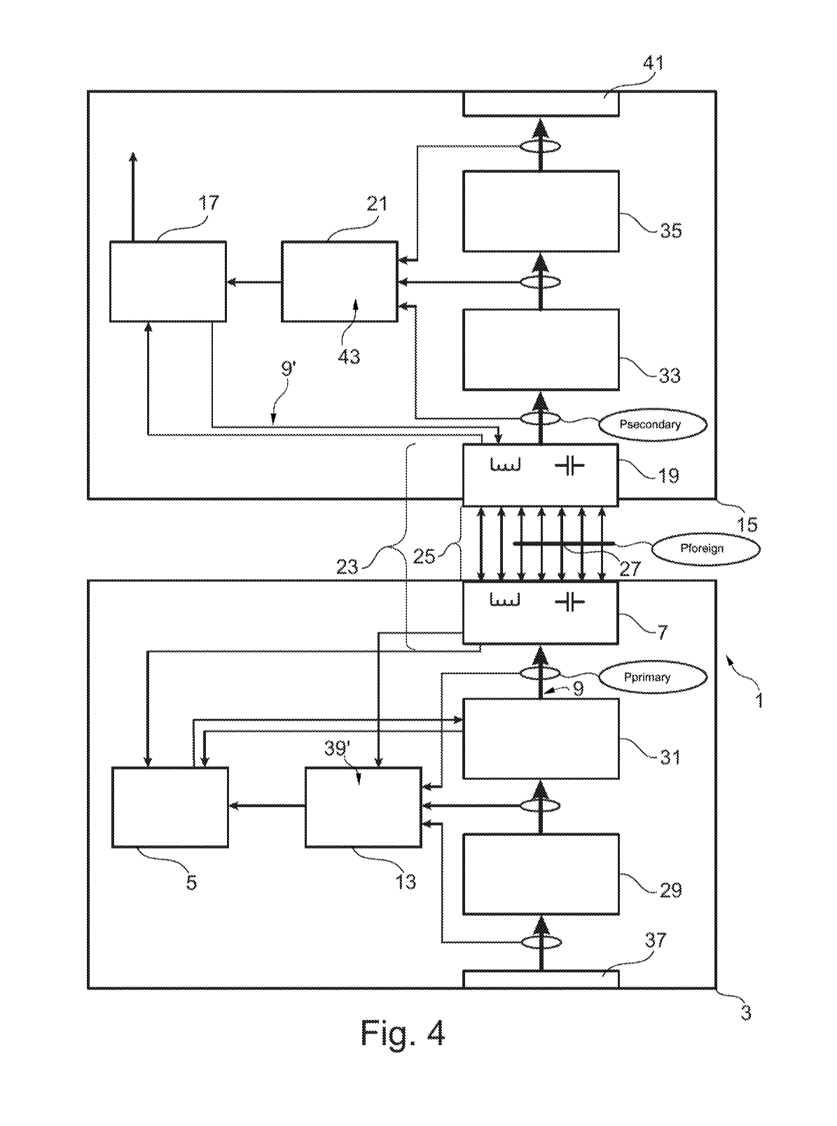

An electrically conductive foreign object 27 as shown in FIG. 2 typically causes interference in the inductive transmission path 23, because in an undesirable manner a voltage is induced in said transmission path 23. However, if this additional current flow is within tolerances that are common during operation, this state is not detected in known systems. For example, known systems are unable to differentiate between a load current of a consumer 41 and a fault current caused by a foreign object 27. In the system 1 according to the invention for this purpose a first measuring unit 13 and if need be a second measuring unit 21 are provided in order to detect the presence of an undesirable electrically conductive foreign object 27 (see FIGS. 3 and 4). Therein, the measuring units 13, 21 are respectively configured for determining a parameter 39, 39′, 43 that in each case is influenced by the presence of the foreign object 27 in the inductive transmission path 23.

FIG. 3 shows a system 1 that is configured for detecting an electrically conductive foreign object 27 by measuring a complex resistance as the first parameter 39, for example on the primary element 7. Furthermore, FIG. 4 shows a system 1 that is configured for detecting a foreign object 27 with reference to a power difference between the primary system 3 and the secondary system 15.

FIG. 3 shows the system 1 according to the invention, which system 1 comprises a primary system 3 and a secondary system 15. The primary system 3 comprises a connection to a mains power supply 37. The mains power supply may be connected to a primary voltage supply 29. The primary voltage supply 29 may preferably be designed, depending on a provided mains voltage, to provide a voltage, for example a direct current voltage that is suitable for the system 1, in the form of a voltage signal. The primary voltage supply 29 may be connected to a primary inverter 31. The primary inverter 31 may, for example, be configured for converting a direct current voltage provided by the primary voltage supply 29 to an alternating current voltage and to provide it in the form of a first energy signal. Therein, the primary inverter 31 may be connected to a primary control unit 5 and may convey a data signal to the primary control unit 5, or may receive a data signal from said primary control unit 5 by way of a data line. By the data signal, predetermined data may be conveyed to the primary control unit 5 or may be received from said primary control unit 5.

The primary control unit 5 may generate a first modulated alternating voltage signal 9 in that, for example, it controls a first modulation unit. Therein, the first modulation unit may be configured for modulating the data signal onto the first energy signal. In this manner, depending on the first energy signal and the data signal, the first modulated alternating voltage signal 9 is generated. Therein, the first modulation unit may, for example, be integrated in the primary inverter 31 or in the primary control unit 5.

If the first modulation unit is, for example, integrated in the primary inverter 31, the primary control unit 5 may control the primary inverter 31 and may specify as to how the voltage signal provided by the primary voltage supply 29 is to be modulated. From the primary inverter 31 the first modulated alternating voltage signal 9 may be transmitted to the primary element 7.

In a further exemplary embodiment (not shown in FIG. 3) a first modulation unit may be arranged in the transmission path between the primary inverter 31 and the primary element 7. Furthermore, in this exemplary embodiment the data signal may be provided from the primary control unit 5 directly to the first modulation unit. Therein, the first modulation unit is configured for bringing together the first energy signal of the primary inverter 31 with the data signal and to generate the first modulated alternating voltage signal 9 and to provide it to the primary element 7.

In all the exemplary embodiments the primary element 7 inductively transmits the first modulated alternating voltage signal 9 across the air gap 25. In the secondary system 15 substantially the first modulated alternating voltage signal 9 is received by way of a secondary element 19 and is conveyed to a secondary control unit 17. The secondary control unit 17 demodulates the first modulated alternating voltage signal 9 so that a further data signal may be provided at an output of the secondary control unit 17. Therein, the further data signal is representative of the data signal of the primary system. Demodulation may, for example, take place in a demodulation unit integrated in the secondary control unit 17. Furthermore, the received first modulated alternating voltage signal 9 is conveyed to a secondary rectifier 33, which may also be referred to as a “conversion unit”. The secondary rectifier 33 is configured for providing a second energy signal, depending on the received first modulated alternating voltage signal 9. The second energy signal is conveyed to a secondary voltage generation device 35, which depending on this provides a voltage that is suitable for a consumer 41.

In order to determine a first parameter 39 of the system 1, in the primary system 3 a first measuring unit 13 is provided. The measuring unit 13 may preferably be configured for acquiring current values or voltage values at the primary element 7, depending on them to determine the first parameter 39, and to convey the aforesaid to the primary control unit 5. To this effect the first measuring unit 13 for determining the first parameter 39 may be connected directly to the primary element 7. The determined first parameter 39 may be correspondingly evaluated in the primary control unit 5. For example, as the first parameter 39 a value of a complex resistance of the primary element 7 may be determined. The determined value of the complex resistance may then, for example, be compared with a value stored in the primary control unit 5. If the two values differ by more than a predetermined amount, the presence of a foreign object 27 in the transmission path 23 may be determined, and corresponding measures may be initiated.

The first measuring unit 13 may be configured for determining the first parameter 39, for example continuously or at particular intervals. As an alternative, the first measuring unit 13 may be configured for determining the first parameter 39 when activated by a user. To this effect the first measuring unit 13 may comprise one or several sensors that are directly integrated in the electrical circuit of the primary system 3.

FIG. 4 shows an alternative embodiment of the system 1 in which electrically conductive foreign objects 27 may be detected by a difference in the electrical power between the primary system 3 and the secondary system 15. As already schematically shown in FIG. 1, in the case where no interfering foreign object 27 is present in the transmission path 23, the power balance between the primary system 3 and the secondary system 15 may approximately be balanced so that an electrical power P_{primary} of the primary system approximately corresponds to an electrical power P_{secondary} of the secondary system.

FIG. 2 further shows an unbalanced power balance with the presence of the foreign object 27 in the transmission path 23. Therein, the power P_{primary} provided by the primary system 3 approximately corresponds to the sum of the power P_{foreign} associated with the foreign object 27 and the electrical power P_{secondary} of the secondary system 15.

In the exemplary embodiment in FIG. 4 the first measuring unit 13 is configured for determining current values or voltage values at the outputs of the mains power supply 37, the primary voltage supply 29 and/or of the primary inverter 31, and to convey the aforesaid to the primary control unit 5. In the measuring unit 13 or in the primary control unit 5, depending on the above-mentioned values, the first parameter 39′, namely an electrical power P_{primary} of the primary system 3, may be determined.

Furthermore, in the secondary system 15 an additional second measuring unit 21 is provided, which may preferably be configured for acquiring current values or voltage values at the outputs of the secondary rectifier 33 or of the secondary voltage generation device 35 and depending on them to determine a second parameter 43 or associated values. Therein, the second parameter 43 corresponds to an electrical power P_{secondary} of the secondary system 15. The measured values may, for example, be current values or voltage values at the outputs of the secondary rectifier 33 or of the secondary voltage generation device 35. In addition or as an alternative, the second measuring unit 21 may be configured for determining a corresponding value directly at the secondary element 19 or at the output of the secondary element 19.

Therein, the first measuring unit 13 is connected to the primary control unit 5 and may supply it, for example, with acquired current values and voltage values of the primary system 3. Analogously, the second measuring unit 21 may be in connection with a secondary control unit 17 and may supply it with the acquired current measurement values and voltage measurement values of the secondary system 15.

Furthermore, the secondary control unit 17 is configured for converting the electrical power P_{secondary} of the secondary system 15, which power P_{secondary} has been determined by the second measuring unit 21, to a second modulated alternating voltage signal 9′, and by the secondary element 19 convey it to the primary system 3. Converting the determined electrical power P_{secondary} to the second modulated alternating voltage signal 9′ may, for example, also take place by modulation.

For example, by a second modulation unit integrated in the secondary system (15), the determined second parameter (43) may be converted to the second modulated alternating voltage signal (9′). The second modulation unit may, for example, be integrated in the secondary control unit (17) or may be arranged in the transmission path between the secondary control unit (17) and the secondary element (19). By the secondary element (17) the second modulated alternating voltage signal (9′) may be conveyed across the air gap (25) to the primary element (7). From the primary element (7) the second modulated alternating voltage signal (9′) may be forwarded to the primary control unit (5).

The primary control unit 5 is configured for receiving the second modulated alternating voltage signal 9′ by the primary element 7 and depending on the received second modulated alternating voltage signal 9′ to determine the electrical power P_{secondary} of the secondary system 15, which electrical power P_{secondary} has been conveyed by said alternating voltage signal 9′, and to compare said electrical power P_{secondary} with the electrical power P_{primary} of the primary system 3. The power balance may typically be unbalanced when there is a difference between the electrical power P_{primary} of the primary system and the electrical power P_{secondary} of the secondary system, which difference is greater than a power that is associated with losses, for example transmission losses, in normal operation of the system 1.

In the case of an unbalanced power balance the primary control unit 5 may determine the presence of an electrically conductive foreign object 27 in the transmission path 23. For example, the primary control unit 5 may compare the difference in the electrical power of the primary system 3 and of the secondary system 15 with a predetermined amount. If the difference is larger than the predetermined amount, the primary control unit 5 may, for example, cause the energy supply to the corresponding primary element 7 to be switched off. In order to avoid measuring errors, determining the first parameter 39′ and the second parameter 43 may take place synchronously in the primary system 3 and in the secondary system 15. Therein, synchronization of the primary and secondary systems 3, 15 may, for example, take place by a data exchange. For this purpose, synchronized energy-buffered timers could also be used in the primary and secondary systems 3, 15.

By the system 1 according to the invention it is thus possible to ensure that foreign objects 27 in the transmission path 23 may be detected even with low capacity utilization of the system by consumers 41. This may reduce the installation expenditure and service expenditure required by the system 1. Furthermore, weight and costs may be saved because no additional elements need to be provided that protect the system from foreign objects 27.

Finally, it is mentioned that expressions such as “comprising” or similar do not exclude that further elements or steps may be provided. Furthermore, it should be noted that “a” or “one” do not exclude a plurality. Moreover, features described in the context of the various embodiments may be combined optionally. Furthermore, it should be noted that reference characters in the claims are not to be interpreted as limiting the scope of the claims.

### LIST OF REFERENCE CHARACTERS

1 System for contactless inductive energy transmission
3 Primary system
5 Primary control unit
7 Primary element
9 First modulated alternating voltage signal
9′ Second modulated alternating voltage signal
13 First measuring unit
15 Secondary system
17 Secondary control unit
19 Secondary element
21 Second measuring unit
23 Transmission path
25 Air gap
27 Foreign object
29 Primary voltage supply
31 Primary inverter
33 Secondary rectifier
35 Secondary voltage generation device
37 Mains power supply
39 First parameter (e.g. complex resistance)
39′ First parameter (e.g. electrical power of the primary system)
41 Consumer
43 Second parameter (e.g. electrical power of the secondary system)
P_{Primary} Electrical power of the primary system
P_{Secondary} Electrical power of the secondary system
P_{Foreign} Electrical power associated with a foreign object in the transmission path

1. A system for contactless inductive energy transmission, the system comprising:
a primary system, the primary system comprising
a first modulation unit which is configured for converting a predetermined first energy signal into a first modulated alternating voltage signal;
a primary element which is configured for inductively transmitting the first modulated alternating voltage signal;
a secondary system, the secondary system comprising
a secondary element which is designed for inductively receiving the first modulated alternating voltage signal;
wherein the primary system further comprises a primary control unit and a first measuring unit which is configured for determining a first parameter of the system and for conveying it to the primary control unit;
wherein the primary control unit is configured for determining, depending on the first parameter, whether at least one electrically conductive foreign object is located in the inductive transmission path between the primary element and the secondary element.

2. The system of claim 1, wherein the first modulation unit is configured for converting a predetermined data signal, together with the first energy signal, into the first modulated alternating voltage signal.

3. The system of claim 1, wherein the first measuring unit is configured for determining a complex resistance of the primary element as the first parameter.

4. The system of claim 1, wherein the primary control unit is configured for comparing the first parameter with a predetermined threshold value.

5. The system of claim 4, wherein the primary control unit is configured for generating a warning signal when the first parameter differs from the threshold value by more than a predeterminable amount.

6. The system of claim 1,
wherein the secondary system furthermore comprises a second measuring unit which is configured for determining a second parameter of the secondary system;
wherein the primary control unit is configured for comparing the first parameter with the second parameter, and based on the comparison to determine whether at least one electrically conductive foreign object is located in the inductive transmission path between the primary element and the secondary element.

7. The system of claim 6, wherein the first and the second measuring units are configured for synchronously determining the respectively allocated parameter.

8. The system of claim 6, further comprising a second modulation unit, which is configured for converting the second parameter into a second modulated alternating voltage signal;
wherein the secondary element is configured for transmitting the second modulated alternating voltage signal inductively to the primary element.

9. The system of claim 6, wherein the primary control unit is designed to generate a warning signal when the first parameter differs from the second parameter by more than a predeterminable amount.

10. A method for detecting an electrically conductive foreign object in an inductive transmission path of a contactless inductive energy transmission system of claim 1, the method comprising the following steps:
determining a first parameter of the system by a first measuring unit;
transmitting the first parameter to a primary control unit;
comparing the determined first parameter with a predeterminable threshold value;
issuing a predetermined warning signal when the determined first parameter differs from the threshold value by more than a predeterminable amount.

11. The method of claim 10, further comprising:
determining a second parameter of the secondary system by a second measuring unit;
converting the second parameter by a secondary control unit into a modulated alternating voltage signal;
inductively transmitting the modulated alternating voltage signal to a primary element;
comparing the first parameter to the second parameter by the primary control unit; and
wherein the primary control unit is configured for determining, on the basis of the comparison, whether at least one electrically conductive foreign object is located in the inductive transmission path between the primary element and the secondary element.

12. The method of claim 11, further comprising issuing a warning signal when the first parameter differs from the second parameter by more than a predeterminable amount.

13. An aircraft comprising at least one system of claim 1.
